(19) United States
(12) Patent Application Publication
(10) Pub. No.: US 2019/0312301 A1
(43) Pub. Date: Oct. 10, 2019

(54) LITHIUM AND SODIUM BATTERIES WITH POLYSULFIDE ELECTROLYTE

(71) Applicant: KING ABDULLAH UNIVERSITY OF SCIENCE AND TECHNOLOGY, Thuwal (SA)

(72) Inventors: Mengliu LI, Thuwal (SA); Jun MING, Thuwal (SA); Lain-Jong LI, Thuwal (SA)

(21) Appl. No.: 16/309,301

(22) PCT Filed: Jun. 7, 2017
(86) PCT No.: PCT/IB2017/053375

§ 371 Date: Dec. 12, 2018

Related U.S. Application Data
(60) Provisional application No. 62/353,277, filed on Jun. 22, 2016.

(51) Int. Cl. H01M 10/0525; H01M 10/0569; H01M 4/58; H01M 2/16; H01M 4/40

(52) U.S. Cl. CPC H01M 10/0525; H01M 10/0569; H01M 4/5825; H01M 2/1606; H01M 4/405; H01M 2300/0037; H01M 2/1686

(57) ABSTRACT

A battery comprising: at least one cathode, at least one anode, at least one battery separator, and at least one electrolyte disposed in the separator, wherein the anode is a lithium metal or lithium alloy anode or an anode adapted for intercalation of lithium ion, wherein the cathode comprises material adapted for reversible lithium extraction from and insertion into the cathode, and wherein the separator comprises at least one porous, electronically conductive layer and at least one insulating layer, and wherein the electrolyte comprises at least one polysulfide anion. The battery provides for high energy density and capacity. A redox species is introduced into the electrolyte which creates a hybrid battery. Sodium metal and sodium-ion batteries also provided.

### BACKGROUND

Lithium batteries, including lithium metal and lithium-ion batteries, continue to grow in commercial importance (sodium batteries, including sodium metal and sodium-ion batteries are also of commercial interest but less developed than the lithium counterparts). However, low energy density in the lithium-ion battery still remains as a major issue for handheld devices and vehicle applications. Searching for high capacity cathodes to enhance the total battery energy density has been a focus in battery research. Since the commercialization of rechargeable lithium battery in 1990s, several eminent cathodes including layered lithium metal oxide (LiMO₂, M=Co, Ni, Mn), spinel structured LiM₂O₄ (M=Mn, NiₓMn₁₋ₓ, and the like) and olivine lithium metal phosphate (LiMPO₄, M=Fe, Co, Mn and the like) have dominated the energy markets ranging from portable electric devices to automotive propulsion. However, the insufficient cathode capacity less than 200 mAh g⁻¹ (e.g., <145 mAh g⁻¹ of commercialized LiCoO₂) is much lower than that of carbon anode (e.g., about 372 mAh g⁻¹ of natural graphite), which has always been the bottleneck in energy density enhancement. It is a great challenge which needs to be solved urgently. Although huge efforts based on solid-state chemistry have been paid for synthesizing new cathodes such as gradient nickel rich and lithium rich compounds with higher capacity, the durable cycle life and stable voltage plateau still warrant further investigation. Among the commonly used cathode materials, the olivine LFP (“lithium iron phosphate”) is an exceptional host for lithium ions storage because of its preponderant safety and rate capability (i.e. robust crystalline structure and large channels formed by the corner-connected octahedral FeO₆ and tetrahedral PO₄) over the layered oxide cathode. But the intrinsic low capacity is the major impediment for expanding their utilizations so that a theoretical capacity of 170 mAh g⁻¹ is reached. Thus, it would be extremely attractive to enhance the capacity and cycle performance of LFP-based Li-ion battery for wider applications.

Prior art references include the text, Yoshio, Brodd, Kozawa (Eds.), Lithium-In Batteries, Science and Technologies, Springer, 2009 (“Yoshio text”), including chapters 4 and 19 which relate to electrolytes. See also U.S. Pat. Nos. 5,882,812 and 5,962,171 and U.S. Patent Publications 2013/010891 3 and 2014/0023936. See also Hayner et al., Annu. Rev. Chem. Biomol. Eng. 2012, 3: 445-71; Besenhard et al., J. Power Sources, 43-44, 413 (1993); and Wanger et al., J. Power Sources, 68, 328 (1997).

A need exists for better lithium-based battery devices providing higher energy densities and capacities.

### SUMMARY

Embodiments described herein include, for example, devices such as batteries and components thereof including, for example, compositions, separators, and electrodes, as well as methods of making and methods of using such batteries and components.

An aspect provided herein includes a battery comprising: at least one cathode, at least one anode, at least one battery separator, and at least one electrolyte disposed in the separator, wherein the anode is a lithium metal or lithium alloy anode or a lithiated anode adapted for intercalation of lithium ion, wherein the cathode comprises material adapted for reversible lithium extraction from and insertion into the cathode, and wherein the separator comprises at least one porous, electronically conductive layer and at least one insulating layer, and wherein the electrolyte comprises at least one polysulfide anion. Another aspect is a hybrid lithium ion-lithium sulfur battery.

In one embodiment, the polysulfide anion is from lithium polysulfide and the electrolyte comprises at least two organic solvents. In one embodiment, the polysulfide anion is from lithium polysulfide and the electrolyte comprises at least two lithium salts which are different than the lithium polysulfide.

In one embodiment, the porous, electronically conductive layer is a carbon layer. In one embodiment, the porous, electronically conductive layer is a carbon nanotube layer.

In one embodiment, the cathode is a layered material or a spinel material. In one embodiment, the cathode comprises lithium iron phosphate (LFP).

In one embodiment, the anode is an anode adapted for intercalation of lithium ion. In one embodiment, the anode comprises graphite.

In one embodiment, the polysulfide anion is from lithium polysulfide, wherein the porous, electronically conductive layer is a carbon layer, and wherein the cathode is a layered material or a spinel material.

Another embodiment is a battery comprising: at least one cathode, at least one anode, and at least one electrolyte, wherein the electrolyte comprises at least one polysulfide anion, wherein the battery is a lithium metal, a lithium ion, a sodium metal, or a sodium ion battery. In one embodiment for the sodium metal or sodium ion battery, the polysulfide anion is from sodium polysulfide.

In different embodiments, the batteries described herein can be in a charged or discharged state.

In selected embodiments, a strategy is provided based on, at least in part, using a polysulfide anion electrolyte for boosting the performance of the battery, such as an LFP Li-ion battery. This newly designed electrolyte, in selected embodiments, is able to lower the polarization and improve the cycle stability of a battery such as an LFP-based Li-ion battery. Meanwhile, the redox reaction potential of, for example, the polysulfide salt, Li₂S₈, falls in the voltage-window of, for example, LFP during the charge/discharge process, thus contributing additional voltage plateaus at around 2.0 V.

As a result, a completely new hybrid battery comprising, for example, Li/LFP and Li-S systems, was developed, which can deliver a high capacity of 442 mAh g_{LFP}⁻¹. The stability and rate capabilities of the preferred embodiments for the hybrid battery are also overwhelmingly better than current Li-ion battery.

Additional advantages for one or more embodiments are described or inherently provided hereinafter.

### BRIEF DESCRIPTION OF THE DRAWINGS

FIG. 1. Schematic drawing of hybrid lithium ion battery and electrochemical performances. (a) Assembly of hybrid lithium battery consisting of LFP cathode, CNTs-modified separator and lithium metal (or lithiated graphite), in which the electrolyte of 1.0 M LiTFSl, 0.4 M LiNO₃ in DOL/DME containing 0.05 M Li₂S₈ is used. (b) typical voltage vs. capacity profiles of hybrid battery at 0.6C. (c) cycle performance and (d) rate capability of batteries using different kind of electrolytes.

FIG. 2. Comparative over-potential of battery using different kind of electrolyte. Voltage vs. capacity profiles of (a) electrolyte with Li₂S₈, (b) commercial electrolyte, and (c) electrolyte without Li₂S₈ at the rate of 0.25C, 0.6C and 1.2C, charged to 3.6 V. (d) calculated over-potential for charge-discharge curves using different kind of electrolytes. (e, f) Comparative voltage vs. capacity profiles of Li₂S₈-based (solid line) and commercial electrolyte (dot line) at the high rates of 2.5C, 6C and 12C charged to 4.0 V.

FIG. 3. Electrochemical analysis and mechanism. Plots of normalized peak current (iₚ) with the square root of the scan rate (ν^{1/2}) for (a) Li₂S₈-based electrolyte and (b) commercial electrolyte. The impedance spectra for batteries using three electrolytes after (c) first CV scan and (d) last CV scan. Inset of FIG. (c) is the enlarged image for electrolyte with Li₂S₈ at high frequency range. (e) Schematic diagram of the mechanism during charge and discharge process with Li⁺ extraction/insertion. The core-shell model represents the electrodes with two coexist phase LiFePO₄ and FePO₄. The polysulfide electrolyte is filled with Sₓ²⁻ ions. The gradient color of model illustrates the variation of structure accompanying the insertion/extraction of lithium ion.

FIG. 4. Electrochemical performances of full battery. (a). Typical voltage vs. capacity profiles and (b) cycle performance of hybrid LFP/graphite with Li₂S₈-based electrolyte and normal LFP/graphite lithium ion battery in initial 500 cycles under 0.6C.

FIG. 5. (a) Coating multi-walled carbon nanotube (MWCNT) on glass fiber. (b) Cross-sectional scanning electron microscope (SEM) images of MWCNT modified glass fiber separator. (c) Surficial and (d) sectional morphology in a high magnification.

FIG. 6. (a) SEM of cycled CNTs-separator and relative (b) elemental mapping images. (c) SEM of cycled LFP cathode and (d) elemental mapping images. The colour of red, yellow, and blue-green represent the distribution of carbon, sulfur and LiFePO₄, respectively. (e) Energy-dispersive X-ray spectroscopy of battery using Li₂S₈-based electrolyte.

FIG. 7. (a) Rate capability of hybrid battery using Li₂S₈-based electrolyte. (b) Cycle performance of LFP lithium battery under 0.6C and (c) C-rate test using commercial LIB electrolyte and (d) electrolyte without Li₂S₈. (e) Comparison for batteries using Li₂S₈-based electrolyte (solid line) and commercial LIB electrolyte (dash line) at the high rates of 2.5C, 6C, and 12C charged to 4.0 V.

FIG. 8. Proposed reaction routine of LFP cathode and Li₂S₈ species in electrolyte during the charge-discharge process.

FIG. 9. Comparative cycle performance and typical voltage vs. capacity profiles of battery using (a, d) Li₂S₈-based and (b, c) commercial electrolyte.

FIG. 10. Comparative Cyclic voltammetry of lithium LFP battery using electrolyte with Li₂S₈ and commercial electrolyte scanning from (a) 0.075 mV s−1, (b) 0.1 mV s−1 to (c) 0.25 mV s−1. The EIS spectra of batteries using (d) electrolyte with Li₂S₈, (e) commercial electrolyte, and (f) electrolyte without Li₂S₈ after each scan.

The polarization of battery using Li₂S₈-based electrolyte are about 347.9 mV, 364.9 mV, and 465.9 mV, significantly lower than 420.5 mV, 439.0 mV and 555.7 mV of commercial Li-ion battery electrolyte as increasing the scan rate from 0.075 mV s−1, 0.1 mV s−1 to 0.25 mV s−1. Also, the corresponding charge potentials of 3.61 V, 3.61 V and 3.65 V are much lower than 3.68 V, 3.69 V and 3.79 V of commercial Li-ion battery electrolyte.

FIG. 11. (a) Rate, cycle ability and (b) typical voltage vs. capacity profiles of LFP/graphite full battery in Li₂S₈-based electrolyte. (c, d) Comparative voltage vs. capacity profiles of LFP/graphite full battery using different electrolytes and half battery at the 200^{th} cycles under 0.6C.

### DETAILED DESCRIPTION

### Introduction

Additional embodiments are provided in the following detailed description. It should be noted that the specific embodiments are not intended as an exhaustive description or as a limitation to the broader aspects discussed herein. Also, one aspect described in conjunction with a particular embodiment is not necessarily limited to that embodiment and can be practiced with any other embodiment(s).

References cited herein are incorporated by reference.

Embodiments described herein can be described using terms such as “comprising,” “consisting essentially of,” and “consisting of” as known in the art.

A new strategy is provided in preferred embodiments of integrating a Li₂S₈-based electrolyte with Li-ion batteries to enhance their performance. Taking the olivine LiFePO₄ (LFP) as an example, the polysulfide anion such as, for example, Li₂S₈ species in electrolytes results in lower polarization and superior cycle stability due to the low electrical impedance and fast lithium diffusion. Furthermore, the presence of S₈²⁻/S²⁻ redox reaction from the Li₂S₈ species contributes extra capacity, making a new LFP/Li-S hybridized battery with a high energy density of 1124 Wh kg_{LFP}⁻¹ and a capacity of 442 mAh g_{LFP}⁻¹ over 500 cycles, which is far beyond all cathodes being used in current Li-ion battery technology. In preferred embodiments, the concept of introducing new redox species in electrolyte with a novel cell configuration for Li-ion battery is proposed, which serves as an efficient and scalable approach for obtaining higher density energy storage and conversion devices.

### Batteries

Some basic principles of batteries and electrochemical cells are described. Batteries may be divided into two principal types, primary batteries and secondary batteries. Primary batteries may be used once and are then exhausted. Secondary batteries are also often called rechargeable batteries because after use they may be connected to an electricity supply, such as a wall socket, and recharged and used again. In secondary batteries, each charge/discharge process is called a cycle. Secondary batteries eventually reach an end of their usable life, but typically only after many charge/discharge cycles.

Secondary batteries are made up of an electrochemical cell and optionally other materials, such as a casing to protect the cell and wires or other connectors to allow the battery to interface with the outside world. An electrochemical cell includes two electrodes, the positive electrode or cathode and the negative electrode or anode, an insulator separating the electrodes so the battery does not short out, and an electrolyte that chemically connects the electrodes.

In operation the secondary battery exchanges chemical energy and electrical energy. During discharge of the battery, electrons, which have a negative charge, leave the anode and travel through outside electrical conductors, such as wires in a cell phone or computer, to the cathode. In the process of traveling through these outside electrical conductors, the electrons generate an electrical current, which provides electrical energy.

At the same time, in order to keep the electrical charge of the anode and cathode neutral, an ion having a positive charge leaves the anode and enters the electrolyte and a positive ion also leaves the electrolyte and enters the cathode. In order for this ion movement to work, typically the same type of ion leaves the anode and joins the cathode. Additionally, the electrolyte typically also contains this same type of ion. In order to recharge the battery, the same process happens in reverse. By supplying energy to the cell, electrons are induced to leave the cathode and join the anode. At the same time a positive ion, such as Li⁺, leaves the cathode and enters the electrolyte and a Li⁺ leaves the electrolyte and joins the anode to keep the overall electrode charge neutral.

In addition to containing an active material that exchanges electrons and ions, anodes and cathodes often contain other materials, such as a metal backing to which a slurry is applied and dried. The slurry often contains the active material as well as a binder to help it adhere to the backing and conductive materials, such as a carbon particles. Once the slurry dries it forms a coating on the metal backing.

Unless additional materials are specified, batteries as described herein include systems that are merely electrochemical cells as well as more complex systems. Several important criteria for rechargeable batteries include energy density, power density, rate capability, cycle life, cost, and safety. The current lithium-ion battery technology based on insertion compound cathodes and anodes is limited in energy density. This technology also suffers from safety concerns arising from the chemical instability of oxide cathodes under conditions of overcharge and frequently requires the use of expensive transition metals.

Thicknesses of different components such as electrodes and separators can be adapted for the need. Surfaces can be adapted and treated for the need.

Batteries can be in a charged, partially charged, discharged, or partially discharged states.

Batteries can be incorporated into larger systems.

Batteries can include additional parts such as current collectors and external electrical circuitry.

The assembly of batteries is described elsewhere herein.

Hybrid batteries can be prepared which are based on more than one redox reaction. For example, herein a hybrid lithium ion-lithium sulfur battery is described which can comprise the electrolytes, separators, cathodes, and anodes described herein.

### Electrolyte

Electrolytes are known in the art. See, for example, Yoshio text, including chapters 4 and 19. They can be liquid, gel, or solid electrolytes. The electrolyte comprises at least one polysulfide anion. Polysulfide anions are known in the art, and metal polysulfides and polysulfide salts are known in the art. See, for example, U.S. Patent Publication 2015/0340738; 2014/0255797; 2014/0342214; and 2014/0023936. The electrolyte can comprise at least one solvent, preferably at least one organic solvent, preferably at least one aprotic solvent. Multiple solvents and/or multiple salts can be used in the electrolyte. One or more additives can also be used.

The polysulfide anion can be provided as a salt mixed into a larger electrolyte composition. The metal of the salt can be, for example, lithium, sodium, or magnesium, but preferably lithium polysulfide is used. Lithium polysulfide can be represented as Li₂Sₓ wherein 2<x<8. In a preferred embodiment, the lithium polysulfide is represented as Li₂S₈.

Methods of forming polysulfide anions including lithium polysulfide are known in the art. For example, lithium can be mixed with sulfur and reacted.

Solvents as electrolytes are well-known in the art and can be aqueous or non-aqueous. However, non-aqueous solvents are preferred. Mixtures of solvents can be used. One or more organic solvents can be used, including one or more aprotic solvents, one or more etheric solvents, or one or more oxygenated solvents. Other examples of the one or more solvents include open-chain or cyclic carbonates, carboxylic acid esters, nitrites, ethers, sulfones, sulfoxides, lactones, dioxolanes, glymes, crown ethers, and any mixture thereof. Preferred examples of solvents include 1,3-dioxolane (DOL) and 1,2-dimethoxyethane (DME).

Illustrative electrolyte solvents include, but are not limited to, acetals, ketals, sulfones, acyclic ethers, cyclic ethers, glymes, polyethers, dioxolanes, substituted forms of the foregoing, and blends or mixtures of any two or more such solvents. Examples of acyclic ethers that may be used include, but are not limited to, diethyl ether, dipropyl ether, dibutyl ether, dimethoxymethane, trimethoxymethane, dimethoxyethane, diethoxyethane, 1,2-dimethoxypropane, and 1,3-dimethoxypropane. Examples of cyclic ethers that may be used include, but are not limited to, tetrahydrofuran, tetrahydropyran, 2-methyltetrahydrofuran, 1,4-dioxane, 1,3-dioxolane, and trioxane. Examples of polyethers that may be used include, but are not limited to, diethylene glylcol dimethyl ether (diglyme), triethylene glycol dimethyl ether (triglyme), tetraethylene glycol dimethyl ether (tetraglyme), higher glymes, ethylene glycol divinylether, diethylene glycol divinylether, triethylene glycol divinylether, dipropylene glycol dimethylether, and butylene glycol ethers. Examples of sulfones that may be used include, but are not limited to, sulfolane, 3-methyl sulfolane, and 3-sulfolene.

In some embodiments, the electrolyte solvent includes, but is not limited to, 1,2-dimethoxy ethane (DME), 1,3-dioxolane (DOL), tetraethyleneglycol dimethyl ether (TEGDME), tetrahydrofuran (THF), and tri(ethylene glycol)dimethyl ether. Mixtures of any two or more such solvents may also be used. For example, a mixture of DME:DOL is illustrated in the examples, but other mixtures may be used. Where a mixture of two of the solvents is used, the ratio of mixing may be from 1 to 99 of a first solvent and from 99 to 1 of a second solvent. In some embodiments, the ratio of the first solvent to the second solvent is from 10:90 to 90:10. In some embodiments, the ratio of the first solvent to the second solvent is from 20:80 to 80:20. In some embodiments, the ratio of the first solvent to the second solvent is from 30:70 to 70:30. In some embodiments, the ratio of the first solvent to the second solvent is from 40:60 to 60:40. In some embodiments, the ratio of the first solvent to the second solvent is about 1:1. For example, as illustrated in the examples, one mixture is that of DME:DOL at a ratio of about 1:1.

Additional lithium salts can be used which are not particularly limited including, for example, lithium bis(trifluoromethane)sulfonamide salt (LiTFSl) and lithium nitrate salt. Examples of additional lithium salts include LiBF₄, LiPF₆, and lithium bis-pentafluoroethanesulfonylimide (BETI).

The amounts of the electrolyte components, such as polysulfide and solvent, can be varied as known in the art.

A preferred electrolyte is prepared with use of, or comprises, lithium polysulfide (Li₂S₈), LiTFSI, and lithium nitrate as salt components and a solvent mixture of DOL and DME.

### Separator

Battery separators are known in the art (e.g., see Yoshio text, including chapter 20) and can be, for example made from glass, polymers, or the like. They are porous and contain electrolyte in the pores. They can include an electrically insulating layer but allow the electrolyte to conduct ions. The separator can be made from, for example, a polymer such as a polyolefin such as polypropylene or polyethylene.

Suitable separators include those such as, but not limited to, microporous polymer films, glass fibers, paper fibers, and ceramic materials. Illustrative microporous polymer films include, but are not limited, nylon, cellulose, nitrocellulose, polysulfone, polyacrylonitrile, polyvinylidene fluoride, polypropylene, polyethylene, polybutene, or a blend or copolymer thereof. In some embodiments, the separator is an electron beam treated micro-porous polyolefin separator. In some embodiments, the separator is a shut-down separator. Other separators may include a microporous xerogel layer, for example, a microporous pseudo-boehmite layer as described in U.S. Pat. No. 6,153,337. Commercially available separators include those such as, but not limited to, Celgard® 2025 and 3501, and 2325; and Tonen Setela® E25, E20, and Asahi Kasei® and Ube® separators.

Separators of a wide range of thickness may be used. For example, the separator may be from about 5 microns to about 50 microns thick. In other embodiments, the separator is from about 5 microns to about 25 microns.

The battery separator can be made to be bifunctional. Examples of bifunctional separators are described in, for example, U.S. Patent Publication 2015/0318532 and Chung et al., J. Phys. Chem. Lett., 2014, 5(11), 1978-1983. Other examples are described in Zhu et al., Nano Energy, 20, 176-184 (2016) and Kannan et al., ECS Meeting Abstracts, MA 2015-01 239 (May 25, 2015).

In the bifunctional separator, for example, a porous, electronically conductive layer can be included in the structure along with the insulating layer. The layer can include materials such as carbon, carbon powder, carbon nanotubes, including multi-walled carbon nanotubes and interwoven carbon nanotubes, graphene, and other forms of carbon. The electronically conductive layer can include a polymeric binder if desired. The electronically conductive layer can be disposed on the cathode side of the separator.

### Cathode

Battery cathodes (positive electrodes) are generally known in the lithium battery art. See, for example, Yoshio text, including chapter 2. The cathode can be adapted for intercalation, extraction, insertion, or diffusion of the lithium cation. Transition metal oxides can be used. Spinel and layered materials can be used. An example is manganese spinel cathode material. Two- or three-dimensional diffusion of lithium ion can be used. Materials with layered structures include, for example, LiFePO₄, LiCoO₂, LiNiO₂, LiCrO₂, Li₂MoO₃, Li_{0.7}MnO₂, LiNi_{0.8}CO_{0.2}O₂, LiNi_{0.8}CO_{0.15}O₂, LiMn_{0.5}Ni_{0.5}O₂, LiMn_{1/3}Ni_{1/3}Co_{1/3}O₂, LiMn_{0.4}Ni_{0.4}Co_{0.2}O₂, LiMn₂O₄, Li_{1.06}, Mg_{0.06}, Mn_{1.88}O₄, and LiAlMnO₄. The cathode material can be doped if desired. For example, LiCoO₂ can be doped with aluminum or magnesium. LiNiO₂ can be doped with a foreign metal.

However, a particularly preferred embodiment is LiFePO₄, particularly with the olivine structure.

As known in the art, conductive materials such as carbon and binder materials such as polymers can be used to construct an electrode including the cathode.

### Anode

Anodes are also generally known in the lithium battery art. See, for example, Yoshio text, including Chapter 3. The anode can be a metallic lithium anode or an anode in which lithium ion is present. Alloys can be made including lithium with, for example, Sn, Si, Al, SB, SnB_{0.5}Co_{0.5}O₃, or Li_{2.6}Co_{0.4}N.

As known in the art, conductive materials such as carbon and binder materials such as polymers can be used to construct an electrode including an anode. Lithiated carbon anodes can be used. Carbonaceous anodes can be used including graphite anodes.

Other embodiments for carbon anodes include, for example, spherical graphitized mesocarbon microbeads (MCMB), graphitized carbon fiber (MCF), pitch base graphite, and carbon-coated natural graphite.

### Sodium Metal and Sodium Ion Embodiments

Other embodiments include sodium metal and sodium ion batteries. For example, one embodiment provides for a battery comprising: at least one cathode, at least one anode, and at least one electrolyte, wherein the electrolyte comprises at least one polysulfide anion, wherein the battery is a lithium metal, a lithium ion, a sodium metal, or a sodium ion battery. In one embodiment, the battery is a lithium metal or a lithium ion battery, and in another embodiment, the battery is a sodium metal or a sodium ion battery.

Sodium metal and sodium ion batteries are known in the art. Such batteries are described in, for example, J. Sudworth, A. R. Tiley, Sodium Sulfur Battery, 1986; Lithium Batteries, Advanced Technologies and Applications (Eds. B. Scrosati et al.), Chapter 16, “Rechargeable Sodium and Sodium-Ion Batteries,” 2013. See also, Luo et al., ACS Cent. Sci., 2015, 1(8), 420-422; and Seh et al., ACS Cent. Sci., 2015, 1, 449-455.

For the sodium and sodium-ion embodiments, the anode, cathode, and electrolyte, and other aspects of the battery are adapted as known in the art to accommodate the use of sodium rather than lithium. The electrolyte can include an organic solvent such as one or more glymes (mono-, di-, or tetraglyme), and the sodium salt can be, for example, NaPF₆, NaN(SO₂CF₃)₂, NaN(SO₂F)₂, NaSO₃CF₃, or NaClO₄.

Na₂S₈ can be prepared and used as the polysulfide anion.

### Performance

The performance of the batteries can be tested by methods known in the art and use of the methods shown in the working examples. Performance parameters include, for example, energy density and/or capacity. While individual performance parameters are important, more important are combinations of performance parameters. For example, high energy density can be combined with high capacity.

In one embodiment, the energy density can be, for example, at least 1,000 Whkg⁻¹, or at least 1,100 Whkg⁻¹, wherein kg is linked to the cathode material such as an LFP cathode.

In one embodiment, the capacity can be, for example, at least 300 mAhg⁻¹, or at least 400 mAhg⁻¹, wherein g is linked to the cathode material such as an LFP cathode.

Testing can be done through a series of charge/discharge cycles and can be done, for example, for at least 100 cycles, or at least 250 cycles, or a least 500 cycles, or at least 1,000 cycles.

In one embodiment, the capacity can be, for example, at least 75 mAhg⁻¹, or at least 125 mAhg⁻¹, or at least 145 mAhg⁻¹, after 500 cycles, wherein g is linked to the cathode material such as an LFP cathode.

The battery voltage can be, for example, at least 3 V, or at least 3.5 V, or at least 4 V.

Polarization performance can be lowered as reflected in lowering of charge voltage. Over-potential is lowered.

Cycle stability can be improved.

Cyclic voltammetry (CV) can be used to study the performance.

C-rate testing can be carried out including testing at, for example, 0.25C, 0.6C, 1.2C, 2.5C, 6C, and 12C, wherein one defines 1C as 1C=170 mAh g⁻¹.

Buffer effects can be measured where voltage is maintained despite significant or full discharge.

### Methods of Making

The batteries can be made by methods known in the art and use of the methods shown in the working examples. See, for example, Yoshio text, chapter 8. Battery components to be assembled include, for example, the case or can, the positive terminal, the positive current collector, the positive active mass, the separator, the negative active mass, the negative current collector, and the negative terminal.

Different types of cells can be made including, for example, cylindrical cells, prismatic cells, polymer cells, and flat plate cells.

The cells can be assembled in a discharged condition and can be activated by charging. A solid electrolyte interface (SEI) can be formed.

Safety factors and external electrical circuits can be designed into the batteries.

### Applications and Methods of Using

Batteries can be used in many applications known in the art and developed in the future including energy storage, portable electrical devices, and vehicle or automotive propulsion. Biomedical applications are also important.

### WORKING EXAMPLES

Additional embodiments are provided in the following working examples.

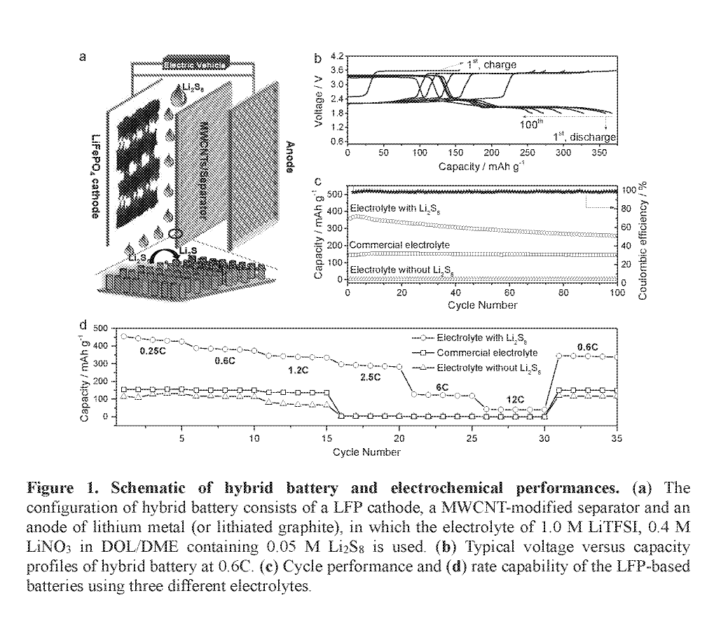

FIG. 1a schematically illustrates the structure of the hybrid battery, where the commercial LFP and Li (or lithiated graphite) was used as the cathode and anode.

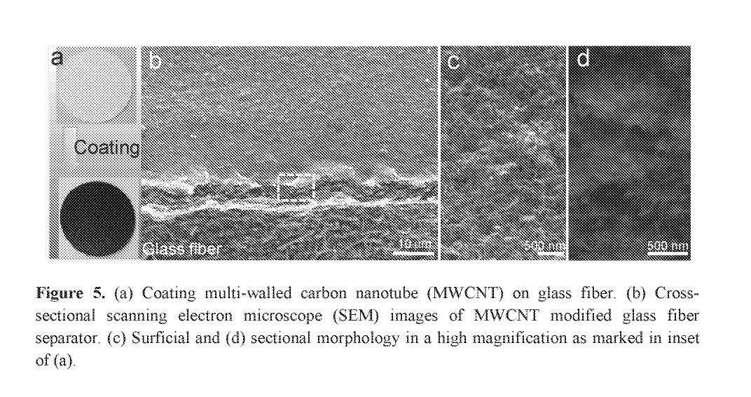

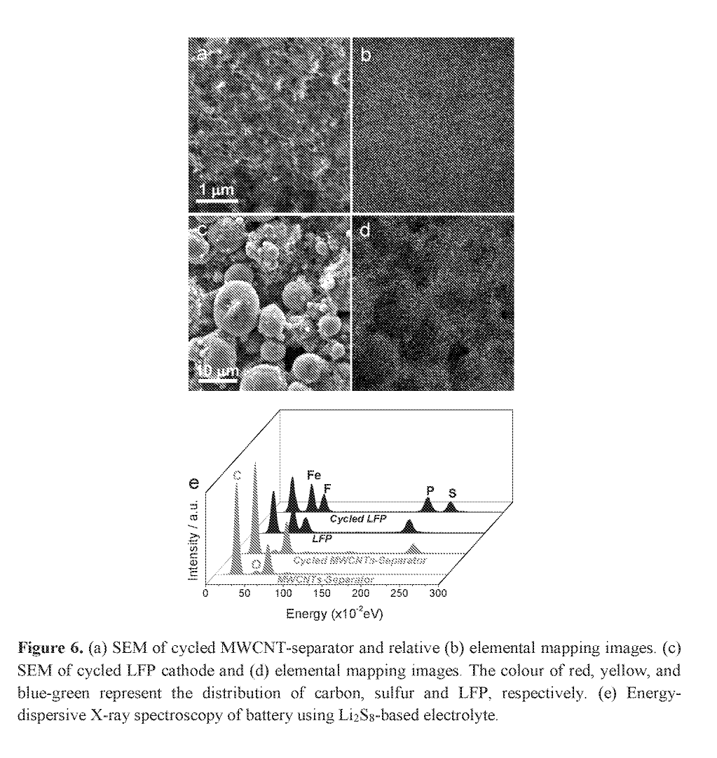

The electrolyte was composed of 1 M bis(trifluoromethane) sulfonimide lithium salt (LiTFSI) in 1,3-dioxolane (DOL)/1,2-dimethoxyethane (DME) (v/v, 1/1), 0.4 M LiNO₃ and 0.05 M Li₂S₈. Since the redox reaction of Li₂S₈/Li₂Sₓ (2≤x_{<}8) is involved in the charge/discharge process, the separator was coated with multi-walled carbon nanotubes (MWCNTs) (FIG. 5) to host the sulfur species as well as the reaction. FIG. 6 shows the scanning electron microscopy (SEM) images and elemental mappings of the cycled MWCNT separator and LFP cathode respectively, which indicates that the sulfur species was distributed on the side of cathode.

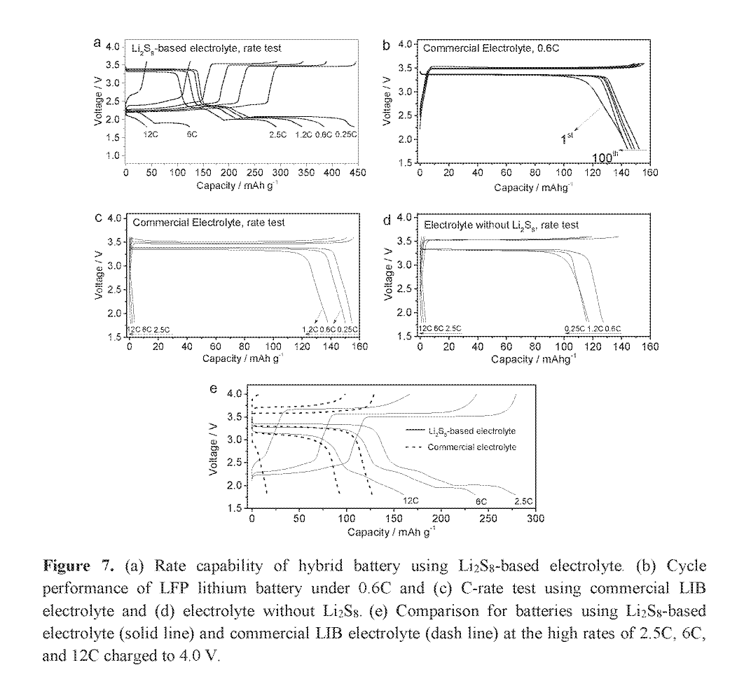

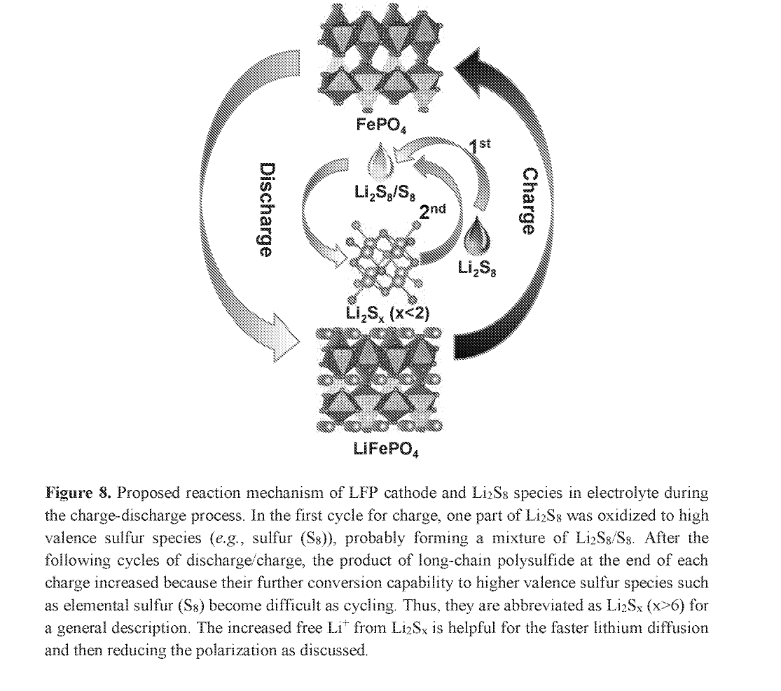

Different from the conventional electrolyte used for Li-ion battery, the Li₂S₈-based electrolyte used herein could largely enhance the overall capacity using the same volume of electrolyte. To understand the effect clearly, two other electrolytes were compared: (i) commercial Li-ion battery electrolyte (1 M LiPF₆ in ethylene carbonate/dimethyl carbonate (EC/DMC)), and (ii) Li-S electrolyte without Li₂S₈ (1 M LiTFSl in DOL/DME with 0.4 M LiNO₃). FIG. 1b shows the charge/discharge profiles for the hybrid battery at 0.6 C. During the first charge, the initial charge plateau at 2.45 V corresponds to the reduction of Li₂S₈ (Li₂S₈→S₈+2Li⁺+2e⁻). Based on the charged capacity of 107 mAh g_{sulfur}⁻¹ charged at this plateau, around half of the Li₂S₈ was oxidized. The following charging platform at around 3.5 V extracts the Li ions located in the crystalline channels of LiFePO₄ (LiFePO₄→Li₁₋ₓFePO₄+xLi⁺+e⁻, x≤1). In the subsequent discharge process, the Li ions insert to the crystalline channel of FePO₄ at 3.45 V first, and then the sulfur in the electrolyte reacts with the Li⁺ to form Li₂S_{x (}1≤x<8) on cathode side (i.e., mainly on MWCNTs), finally giving rise to a total capacity of 370 mAh g_{cathode}⁻¹ at 0.6C and even 442 mAh g_{LFP}⁻¹ at 0.25C (FIG. 7a). The charge/discharge curves for the second cycle and onwards suggest that the battery behaves as a hybrid of Li-ion and Li-S battery (FIG. 8). If one considers only the weight of the LFP cathode (treating Li₂S₈ as an additive in electrolyte), the energy density of this hybrid lithium battery can achieve as high as 1124 Wh kg⁻¹, which is over two times higher than 513 Wh kg⁻¹ of pristine LFP (FIG. 8a) and about 536 Wh kg⁻¹ of commercialized LiCoO₂ in theory. After 100 cycles, the superior capacity and durable cycle performance of the battery using Li₂S₈-based electrolyte can be seen by delivering average capacities of 300 mAh g⁻¹ at 0.6 C, which is much higher than 150 mAh g⁻¹ for commercial Li-ion battery electrolyte (FIG. 1c) at the same cycle rate. The battery using the Li-S electrolyte without Li₂S₈ exhibits the worst performance among these three electrolytes (FIGS. 7b-d).

The excellent performance using the Li₂S₈-based electrolyte showed here are not only the enhanced capacity but also the improved stability. In the C-rate test, the hybrid battery demonstrated high rate capabilities of 437, 381, 339, 288, 122 and 41 mAh g⁻¹ at the rate of 0.25C, 0.6C, 1.2C, 2.5C, 6C and 12C respectively, and it could recover back to 340 mAh g⁻¹ at 0.6C (FIG. 1d). These values are much higher than 155, 151, 137, 3.3, 1.8 and 0.7 mAh g⁻¹ of the battery using commercial electrolyte. Even varied the cut-off voltages to 4.0V, higher rate capacities of 234 and 161 mAh g⁻¹ were attained at the high rates of 6C and 12C for the hybrid battery, which are much better than 92 and 14 mAh g⁻¹ of LFP battery using commercial electrolyte (FIG. 7e). It has already been proved that the electrolyte with LiTFSI in DOL/DME (lithium salt in ether solvents) could suppress the dendritic growth and get a much smoother lithium surface thus largely improves the stability, coulombic efficiency and safety.

One should note that experimental results show that the overall cathode capacity decay with cycling in the hybrid battery is from the Li-S system, known as one issue in Li-S battery. This can be addressed by many approaches such as using a gel/solid electrolyte or blocking layer.

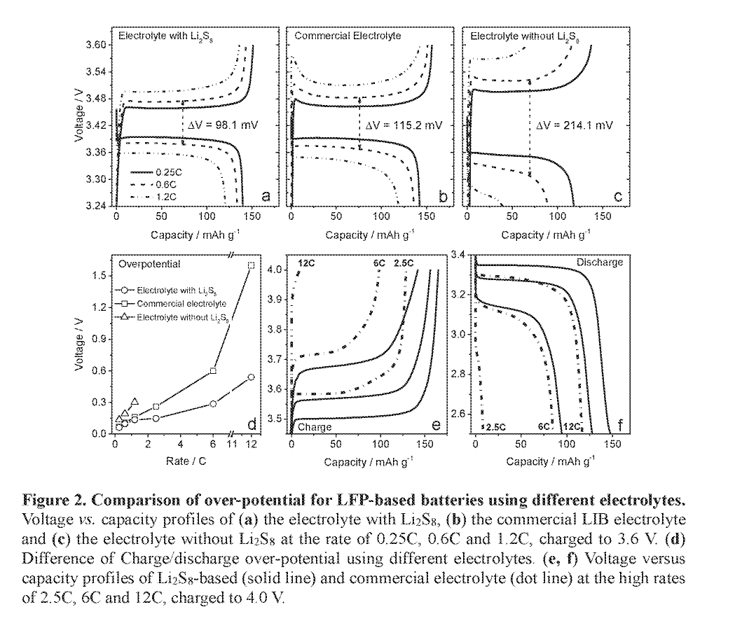

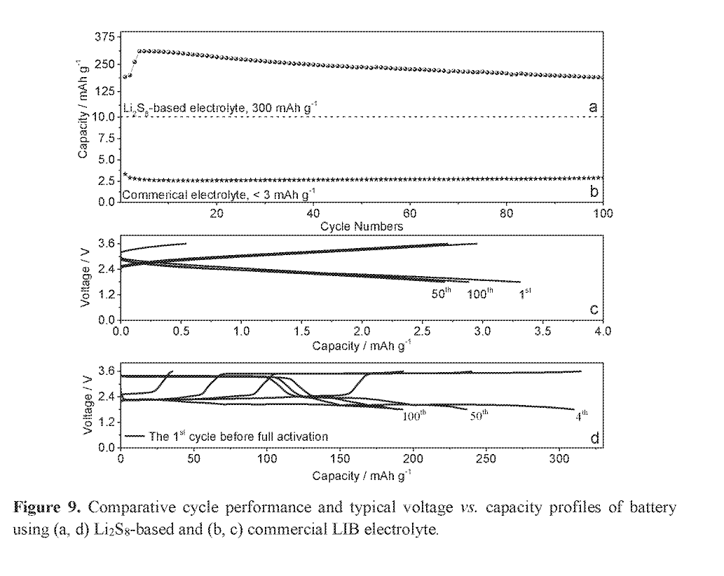

In addition to the above advantages, another benefit of using Li₂S₈-based electrolyte is the lower polarization for the charge and discharge of LFP. FIGS. 2a-c demonstrate the charge/discharge over-potential of batteries using three different electrolytes. The battery using Li₂S₈-based electrolyte shows lowest over-potential and charge platform, highest/smoothest discharge plateau comparing to those with the other two electrolytes at all different charge/discharge rates. FIG. 2d summarizes the over-potential for three batteries using different electrolytes. The advantages of Li₂S₈-based electrolyte over the other two are more obvious at a higher rate (FIGS. 2e and 2f). For example, most lithium ions (i.e., 0.66 Li⁺ vs. 112 mAh g⁻¹) in the channel of LFP can be extracted using the Li₂S₈-based electrolyte at the high rate of 2.5C, but it is impossible in commercial Li-ion battery electrolyte at 3.6 V (i.e., about 3 mAh g⁻¹ only, FIG. 9). A higher charged voltage to 4.0 V is required, but the polarization is more aggravated as further increasing the rate. Considerable lithium ions of 0.88 Li⁺, 0.75 Li⁺ and 0.58 Li⁺ can be extracted/inserted in Li₂S₈-based electrolyte with a lower polarization of 148 mV, 286 mV and 540 mV at 2.5C, 6C and 12C respectively, which is much better than 0.74 Li⁺ (vs. 260mV), 0.54 Li⁺ (vs. 599 mV) and 0.09 Li⁺⁰ (vs. 1600 mV) of LFP battery with commercial Li-ion battery electrolyte. Clearly, such Li₂S₈-based electrolyte can reduce the charge voltage and polarization significantly.

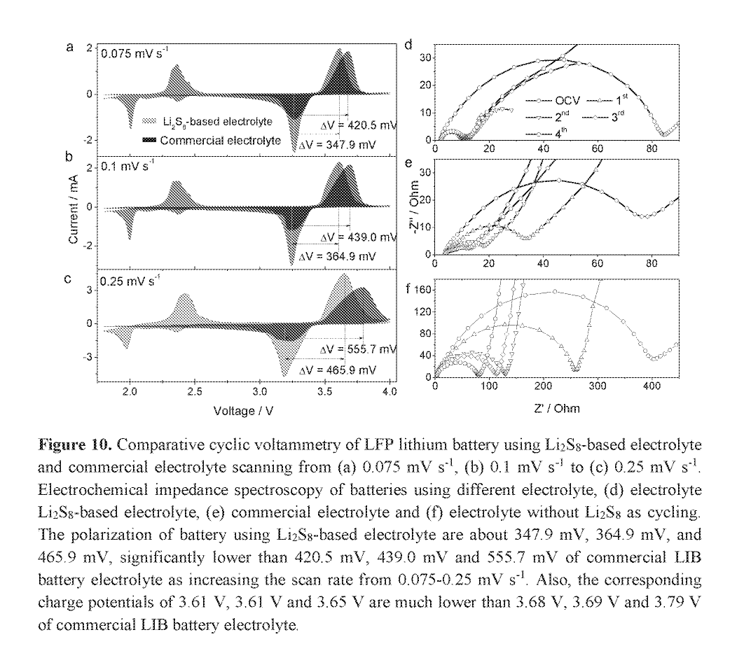

The lower over-potential was further confirmed by the comparative cyclic voltammetry (CV) analysis, in which the oxidation peaks around 2.36 V and 3.60 V correspond to the conversion of Li₂Sₓ to Li₂S₈/S₈ and the extraction of lithium ions from LFP (FIG. 10). The polarization and the charge potentials of battery using Li₂S₈-based electrolyte are significantly lower than commercial Li-ion battery electrolyte as increasing the scan rate. Another distinction of the battery using commercial Li-ion battery electrolyte is that the reduction peak at around 3.25 V is very broad and even tails to 2.5V at a high scan rate, which is in clear contrast with the sharp peaks for the batteries using Li₂S₈-based electrolyte. It indicates the slower insertion rate of lithium ions into the structure of LFP for the battery using commercial Li-ion battery electrolyte.

To interpret the phenomena, the lithium diffusion constant D (cm² s⁻¹) is calculated by the the Randles-Sevcik equation:

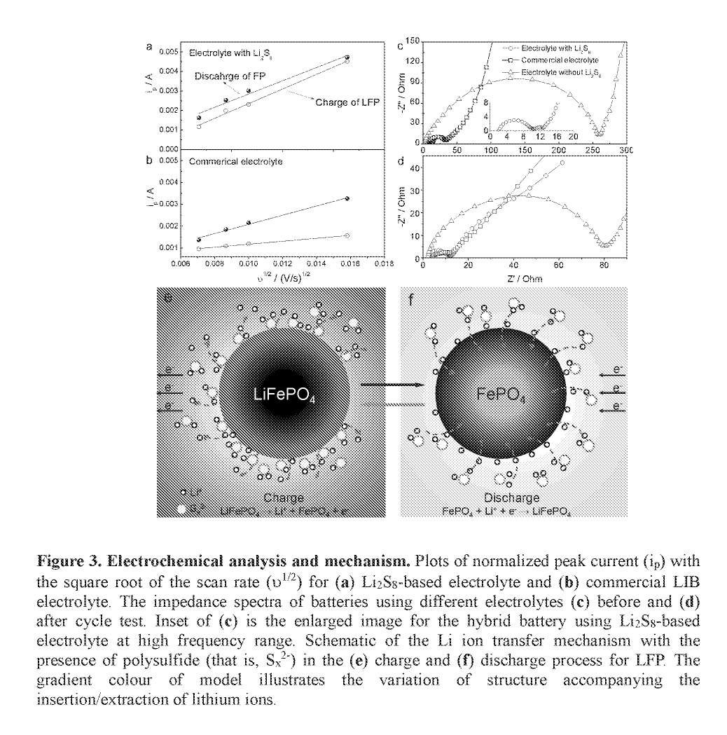

iₚ=2.69×10⁵ n^{3/2} A D^{1/2} C ν^{1/2}

where iₚ indicates the peak current (A), n is the number of electron in the reaction (for LFP, n=1; for polysulfide, taking the first reduction peak at 2.4 V as example, n=2), A is the electrode area (1.33 cm²), u is the scanning rate (V s⁻¹) and C is the variation of lithium-ion concentration in the electrolyte (mol cm⁻³). The plot of the normalized peak current (iₚ) with the square root of the scan rate (ν^{1/2}) is displayed in FIGS. 3a and 3b (calculated values are listed in Table S1). The values of the diffusion constant are extracted as 9.75×10⁻⁶ cm² s⁻¹ and 7.97×10⁻⁶ cm² s−1 for cathodic/anodic current peaks of LFP cathode using Li₂S₈-based electrolyte, much higher than that using commercial electrolyte (3.04×10⁻⁶ cm² s⁻¹ and 3.21×10⁻⁷ cm² s⁻¹). It demonstrates a much faster and more reversible insertion/extraction of lithium ions when using Li₂S₈-based electrolyte, resulting a lower polarization and better electrochemical performance. The impedance spectra were also measured after each CV test to examine the kinetic process (FIGS. 3c and 3d).

The stabilized resistance of hybrid battery using Li₂S₈-based electrolyte (i.e., 8 Ω) is lower than that in commercial electrolyte (i.e., 10 Ω) and that using Li-S electrolyte (i.e., 80 Ω). The additive of Li₂S₈ into Li-S battery electrolyte has significant effects to the final battery performance, apart from the capacity contribution. The role of Li₂S₈ can be described in our presented model: (i) First, soluble Li₂Sₓ (x>6) can be formed at the end of charging, providing abundant free Li⁺ in electrolyte. (ii) In the charging process, the LFP cathode is positively charged. The dissociated/soluble Sₓ²⁻ can gather around the LFP surface by electrostatic interaction and then the extracted Li⁺ can be quickly transported to electrolyte (FIG. 3e); (ii) Inversely for the discharge process, the FePO₄ electrode is negatively discharged (that is, enrichment of Li⁺ on surface). The amount of inserted Li⁺ into FePO₄ can be fast supplemented by Sₓ²⁻ which can transfer Li⁺ from the electrolyte (FIG. 3f). Therefore, faster lithium diffusion and lower electrical impedance give rise to lower polarization and better performance.

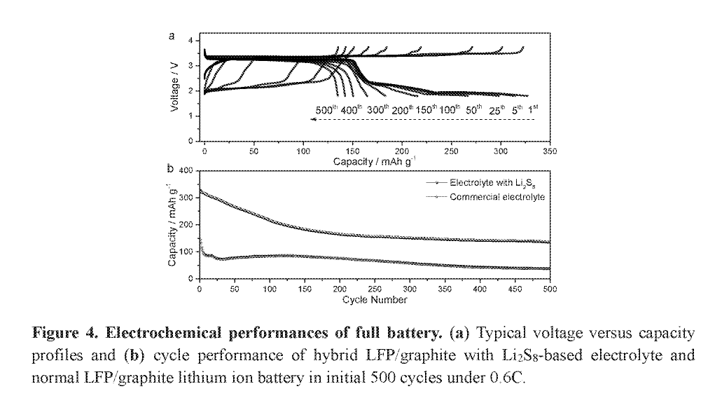

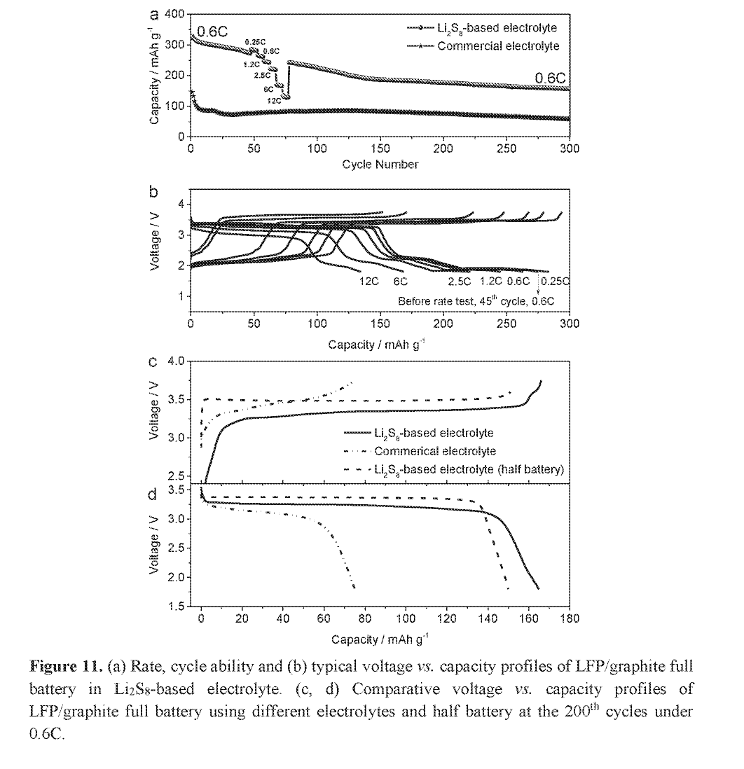

For the practical utilization of Li₂S₈-based electrolyte, the electrochemical behaviour of hybrid lithium ion battery versus graphite was studied in a full battery configuration (FIG. 4a). The full battery could deliver 330 mAh g⁻¹ at 0.6C with fine charge-discharge curves; meanwhile it could stabilize the full battery performances well and maintain the capacity around 145 mAh g⁻¹ after 500^{th} cycles. While for the LFP/graphite full battery, a low capacity of 140 mAh g⁻¹ was obtained and it decayed fast to 80 mAh g⁻¹ in initial cycles, finally retained around 50 mAh g⁻¹ (FIG. 4b). This is a very significant discovery that the redox species not only have the capacity contribution over several hundred cycles but also can stabilize the full battery performance with much lower over-potential. Another interesting function is the buffer effect of redox species that can keep the voltage of hybrid battery around 1.8-2.0 V working for a long time even after the full discharge of LFP, but the voltage of LFP/graphite battery drops straight down without any sign because of the flat discharge plateau of LFP. Thus, the concept of redox species can act as a cushion to detect and maintain the voltage avoiding the instant failure of battery. Further, the reproducible cycle performance over 500 cycles and robust rate capacity at 0.25C-12C fully confirm the availability and stability of this hybrid lithium ion battery (FIG. 11).

In conclusion, an efficient electrolyte chemistry is reported to largely enhance the energy capacity and reduce the polarization of battery by using Li₂S₈-based electrolyte. A completely new hybrid LFP based lithium battery with an extremely high energy density of 1104 Wh kg⁻¹ (i.e., 440 mAh g_{LFP}⁻¹), robust rate capacities and durable cycle performance was presented based on a novel cell configuration. In sum, success was achieved for LFP lithium ion battery versus lithiated graphite with higher capacity, better stability and durable cycle life over 500 cycles in Li₂S₈-based electrolyte.

### Experimental

Materials Preparation: The cathode was composed of 80 wt % LFP (purchased from Lausdeo, Taiwan), 10 wt % Super P carbon and 10 wt % polyvinylidene fluoride (PVDF) binder. In the preparation, the powders were mixed in 1-Methyl-2-pyrrolidinone (NMP) to form a uniform slurry and then casted on Al foil by doctor blade. Dried in vacuum oven at 80° C. for 12h and then punched to Φ13 mm circular electrode. The areal mass density of LFP was controlled at a high loading of 5.21 mg cm⁻² close to practical application. For the CNTs modified separator, the mixture of CNT and PVDF binder with the mass ratio of 9/1 was dispersed into NMP, and then the slurry was casted on the glass fiber separator. The CNTs coated separator was dried first in vacuum oven at 120° C. for 12 h and then cut into Ø18 mm round discs before use. The electrolyte was prepared as below. Stoichiometric ratio of lithium metal pieces and sulfur powder (to form 0.05 M Li₂S₈) were dispersed in 40 mL 1, 3-dioxolane/1, 2-Dimethoxyethane (DOL/DME, v/v, 1/1) and stirred at 80° C. for 48 h. After the reaction, equivalent weight of bis(trifluoromethane) sulfonimide lithium salt (LiTFSI) and LiNO₃ were added into the solution, giving rise to the electrolyte of 1 M LiTFSI in DOL/DME containing 0.4 M LiNO₃ and 0.05 M Li₂S₈. The electrolyte without Li₂S₈ was prepared simply as the second step. The commercial electrolyte 1 M LiPF₆ in ethylene carbonate and dimethyl carbonate (EC/DMC, 50/50, v/v) was purchased from Sigma-Aldrich.

Electrochemical measurements: The electrochemical tests were performed using 2032-type cells. The hybrid lithium ion battery has the configuration of LFP|CNTs modified separator| lithium metal, in which the electrolyte of 1 M LiTFSI, 0.4 M LiNO₃, 0.05 M Li₂S₈ in DOL/DME was used. The amount of the electrolyte was 130 μL and the weight of sulfur was calculated based on the amount of Li₂S₈. For comparison, the lithium ion batteries with the 1 M LiPF₆ in EC/DMC electrolyte were also tested. The batteries were assembled in Argon-filled glovebox in which the moisture and oxygen were strictly controlled below 0.5 ppm. Galvanostatic charge-discharge experiments were carried out by Arbin battery test instrument BT2043 within the voltage window of 1.8-3.6 V and 1.8-4.0V respectively. For the full battery configuration, lithiated graphite was used as anode, and the cut-off voltage was 1.8-3.75V. Cyclic Voltammetry (CV) and electrochemical impedance spectrum (EIS) were recorded by the BioLogic VMP3 under the scan rate 0.05-0.25 mV/s.

Characterizations: A Raman spectrum of electrolyte was carried out by a specific homemade glass tube battery and the spectrum was collected on a Witec alpha 300R Raman spectrometer at a 514 nm excitation wavelength. The interfacial morphology of CNTs-separator and LFP electrode were characterized by the field emission scanning electron microscope (FESEM, FEI Quanta 200), operated at 5 kV and 2.5 mA. The elemental distribution of sulphur, carbon, and LFP were analysed by the energy-dispersive X-ray (EDX) mapping, operated at 10 kV and 6 mA.

TABLE S1
Detail description of linear fitted y = a + b*x
results about the plot of normalized peak current
(iₚ) with the square root of the scan rate (υ^{1/2})

| | | | |
|---|---|---|---|
| Redox peaks | Slope | Intercept | Adj. R-Square |

Li₂S₈-based electrolyte

| | | | |
|---|---|---|---|
| Oxidation peak of LFP | 0.3757 | −0.00141 | 0.99314 |
| Reductive Peak of LFP | 0.33965 | −5.55178E−4 | 0.96812 |
| Reductive peak of Sulphur | 0.05723 | −1.94097E−4 | 0.99803 |

Commercial electrolyte

| | | | |
|---|---|---|---|
| Oxidation peak of LFP | 0.20947 | −1.53462E−5 | 0.98477 |
| Reductive peak of LFP | 0.06759 | 4.98046E−4 | 0.99544 |

1. A battery comprising:
at least one cathode, at least one anode, at least one battery separator, and at least one electrolyte disposed in the separator,
wherein the anode is a lithium metal or lithium alloy anode or a lithiated anode adapted for intercalation of lithium ion, wherein the cathode comprises material adapted for reversible lithium extraction from and insertion into the cathode, and
wherein the separator comprises at least one porous, electronically conductive layer and at least one insulating layer, and wherein the electrolyte comprises at least one polysulfide anion.

2. The battery of claim 1, wherein the polysulfide anion is from lithium polysulfide and the electrolyte comprises at least two organic solvents.

3. The battery of claim 1, wherein the polysulfide anion is from lithium polysulfide and the electrolyte comprises at least two lithium salts which are different than the lithium polysulfide.

4. The battery of claim 1, wherein the porous, electronically conductive layer is a carbon layer.

5. The battery of claim 1, wherein the porous, electronically conductive layer is a carbon nanotube layer.

6. The battery of claim 1, wherein the cathode is a layered material or a spinel material.

7. The battery of claim 1, wherein the cathode comprises lithium iron phosphate (LFP).

8. The battery of claim 1, wherein the anode is an anode adapted for intercalation of lithium ion,

9. The battery of claim 1, wherein the polysulfide anion is from lithium polysulfide, wherein the porous, electronically conductive layer is a carbon layer, and wherein the cathode is a layered material or a spinel material.

10. (canceled)

11. A battery comprising:
at least one cathode, at least one anode, and at least one electrolyte, wherein the electrolyte comprises at least one polysulfide anion, wherein the battery is a lithium metal, a lithium ion, a sodium metal, or a sodium ion battery.

12. The battery of claim 11, wherein the polysulfide anion is from lithium polysulfide and the electrolyte comprises at least two organic solvents.

13. The battery of claim 11, wherein the polysulfide anion is from lithium polysulfide and the electrolyte comprises at least two lithium salts which are different than the lithium polysulfide.

14. The battery of claim 11, wherein the polysulfide anion is from lithium polysulfide, wherein the porous, electronically conductive layer is a carbon layer, and wherein the cathode is a layered material or a spinel material.

15. The battery of claim 11, wherein the polysulfide anion is from Li₂Sₓ, wherein 2<x≤8.

16. A method for forming a battery, the method comprising:
arranging at least one cathode in a battery case or can;
arranging at least one anode in the battery case or can;
arranging at least one battery separator in the battery case or can between the at least one cathode and the at least one anode, wherein
at least one electrolyte is disposed in the separator,
the anode is a lithium metal, lithium alloy anode, or a lithiated anode adapted for intercalation of lithium ion,
the cathode comprises material adapted for reversible lithium extraction from and insertion into the cathode,
the separator comprises at least one porous, electronically conductive layer and at least one insulating layer,
the electrolyte comprises at least one polysulfide anion.

17. The method of claim 16, wherein the polysulfide anion is from lithium polysulfide and the electrolyte comprises at least two organic solvents.

18. The method of claim 16, wherein the polysulfide anion is from lithium polysulfide and the electrolyte comprises at least two lithium salts which are different than the lithium polysulfide.

19. The method of claim 16, wherein the porous, electronically conductive layer is a carbon layer.

20. The method of claim 16, wherein the porous, electronically conductive layer is a carbon nanotube layer.

21. The method of claim 16, wherein the polysulfide anion is from Li₂Sₓ, wherein 2<x<8.
